(19) United States
(12) Patent Application Publication
(10) Pub. No.: US 2008/0129738 A1
(43) Pub. Date: Jun. 5, 2008

(54) METHOD AND APPARATUS FOR RENDERING EFFICIENT REAL-TIME WRINKLED SKIN IN CHARACTER ANIMATION

(75) Inventors: Hang Kee KIM, Taejon (KR); Beom Ryeol LEE, Taejon (KR); Choong Gyoo LIM, Taejon (KR); Junae KIM, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Taejon (KR)

(21) Appl. No.: 11/948,931

(22) Filed: Nov. 30, 2007

(30) Foreign Application Priority Data
Dec. 2, 2006 (KR) 10-2006-0121089
Sep. 10, 2007 (KR) 10-2007-0091685

(51) Int. Cl. G06T 13/00

(52) U.S. Cl. 345/473

(57) ABSTRACT

Provided are an apparatus and method for providing the optimized speed and realistic expressions in real time while rendering wrinkled skin during character animation. The wrinkled skin at each expression is rendered using a normal map and a bump map. Generalized wrinkled skin data and weight data are generated by calculating a difference of the normal and bump maps and other normal and bump maps without expressions. Then, the wrinkled skin data of a desirable character is generated using the generalized wrinkle skin data at each expression, and then the normal and bump maps expressing a final wrinkled skin are calculated using the weight at each expression in a current animation time t. Therefore, the wrinkled skin in animation is displayed.

### BACKGROUND OF THE INVENTION

1. Field of the Invention

The present invention relates to a method and an apparatus for rendering an efficient real-time wrinkled skin during character animation, and more particularly, to a method and an apparatus for smoothly rendering a wrinkled skin of a character used in real-time 3D graphic character rendering fields such as simulations, games, and educations, etc.

This present invention is a result of an IT new growth power core technology development project (an IT R&D project), supported by ministry of information and communication and institute for information technology advancement [project management number: 2006-S-044-01, project name: multi-core CPU and MPU-based cross platform game technology].

2. Description of the Related Art

Real-time 3D graphic fields have been rapidly developed with an increase of hardware improvement and its application fields. Among them, character skin rendering is extensively used in simulations, games, and educations. There have been various efforts in rendering character's skin with fast and realistic expression.

In a conventional art, there are muscle model-based wrinkle rendering, face case model-based animation, subsurface-based skin rendering, and parameter-based face animation according to an anatomical aspect.

The simplest method for rendering character's skin generates polygon meshes necessary for skin rendering, and minutely adjusts the fixed points of polygon meshes. However, this requires a great number of polygons because only the polygons (a set of triangles, each of which includes three fixed points) are used to render a detailed character's expression. Additionally, it takes long time for 3D rendering and it is difficult for 3D modeling.

Another method utilizes a normal map and bump map.

The normal map expresses a normal vector of a character model as texture, and is used to calculate light and an environmental map, which is similar to expressing of the character's skin by putting diffuse color texture on the character model.

The bump map expresses the height of a character model in gray scale and can expresses detailed face expression by rendering the detailed height of the face in the character model.

The normal map and the bump map fast and easily render the detailed curvature of skin through texture.

A wrinkled skin rendering method based on an anatomical muscle model is used to express a wrinkled skin in a face animation. However, since this method requires a great number of calculations and a fixed point based model, it is difficult to be used in a real-time 3D character animation.

On the other hand, a method for rendering a muscle model-based wrinkle according to an anatomical aspect is disposed in Korean Paten Application No. 10-2004-106837, filed on Dec. 14, 2004, entitled “System and its method of generating face animation using anatomy data”.

The conventional art includes an anatomy data storage means, a muscle arrangement means, a skin generation means, an expression generation means. The anatomy data storage means stores skulls corresponding to a plurality of face models, skull geometric information, and muscle information. The muscle arrangement means searches for a skull similar to that of the received face model stored in the anatomy data storage means to generate a face animation after receiving a face model from the external, and then arranges a plurality of muscles in the searched skull. The skin generation means combines the skull having the arranged muscle in the muscle arrangement means with a subcutaneous fat layer and skin to generate a face mesh, and defines the movements of the skin according to the movements of the muscle. The expression generation means contracts and relaxes the corresponding muscle in addition to the subcutaneous fat layer and skin, which are connected to the corresponding muscle, in the generated face mesh by a muscle adjust signal that is inputted from the outside to generate a face mesh with a specific expression.

This conventional art has excellent advantages in rendering a realistic face expression through enormous data to be processed. However, due to its enormous data, the exaggerated expression of the character may not be realistically rendered when necessary.

### SUMMARY OF THE INVENTION

Accordingly, the present invention is directed to a method and an apparatus for rendering an efficient real-time wrinkled skin in character animation, which substantially obviate one or more problems due to limitations and disadvantages of the related art.

It is an object of the present invention to provide a method and an apparatus for effectively rendering a wrinkled skin during face animation by combining normal and bump maps with weight corresponding to the wrinkled skin, and for applying wrinkled skin data extracted from one wrinkled skin of a character model to that of a general character model during character animation.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of rendering a wrinkled skin in real time during character animation, the method including: extracting expression of a character for a normal map synthesis at a current time and calculating weight of a wrinkled skin in a normal map expressed with the wrinkled skin of the expression; adding the calculated weight to calculate a final normal map; and rendering the wrinkled skin by using the calculated final normal map to express the wrinkled skin.

In another aspect of the present invention, there is provided a method of rendering a wrinkled skin in real time during character animation, the method including: extracting expression of a character for a bump map synthesis at a current time and calculating weight of a wrinkled skin in a bump map expressed with the wrinkled skin of the expression; adding the calculated weight to calculate a final bump map; and rendering the wrinkled skin by using the calculated final bump map to express the wrinkled skin.

In a further another aspect of the present invention, an apparatus for rendering a wrinkled skin in real time during character animation, the apparatus including: a normal map module converting cases of necessary expressions into a normal map through an interpolation method after modeling the cases of necessary expressions; a bump map module converting cases of necessary expressions into a bump map through an interpolation method after modeling the cases of necessary expressions; a calculating module adding weight to the normal map or the bump map, the weight corresponding to expressions that will be synthesized with the weight, and synthesizing them, and then calculating the final normal map or the final bump map; and a rendering module rendering a wrinkled skin of a character by using the weighted normal map or the bump map.

As described above, according to weights during character animation, the present invention easily renders a wrinkled skin at a relatively low cost, compared to a muscle-based expression.

Additionally, the present invention applies a generalized wrinkled skin normal map data to all character to easily render a wrinkled skin of the character.

Additionally, the present invention differently render wrinkled skins according to models, such that wrinkled skins of old people can be realistically rendered only when expressions change when a face of old people is applied to that of young people.

The above method is processed in a H/W shader of a graphic processing unit (GPU), such that real-time rendering is possible.

Accordingly, more realistic wrinkled skin can rendered fast in fields dealing with wrinkled skins of animation characters such as 3D games, simulations, educations, etc.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a block diagram of an apparatus for rendering a wrinkled skin in real-time during character animation according to one embodiment of the present invention;

FIG. 2 illustrates a flowchart of a method for rendering a wrinkled skin in real-time during character animation according to one embodiment of the present invention;

FIGS. 3A and 3B illustrate a bump map and a color map used in a character face according to one embodiment of the present invention; and

FIGS. 4A and 4B illustrate a bump map and a weight map expressing smile expression of a character according to one embodiment of the present invention.

### DETAILED DESCRIPTION OF THE INVENTION

Reference will now be made in detail to the preferred embodiments of the present invention, examples of which are illustrated in the accompanying drawings.

FIG. 1 illustrates a block diagram of an apparatus for rendering a wrinkled skin in real-time during character animation according to one embodiment of the present invention.

Referring to FIG. 1, a graphics processing unit (GPU) 10 of the present invention includes a normal map module 12, a bump map module 14, a calculating module 16, and a rendering module 18.

The GPU 10 is a dedicated graphics rendering device receiving data and processing transform and lighting of graphics.

The normal map module 12 converts graphic data inputted from an interface device into a normal map. The normal map module 12 changes the inputted graphic data into the normal map through a case-based module. That is, after modeling a case of necessary expressions in advance (e.g., polygons, a normal map, and a bump map), the normal map is created by interpolating the expression cases.

The bump map module 14 converts graphic data inputted through an interface device into a bump map thorough a case-based model like the normal map module 12.

The calculating module 16 extracts expressions to combine with weight at a current time t, and adds weights to the expressions that correspond to the normal or bump map to obtain a final normal map or a final bump map. That is, when interpolating the normal maps, the weight is given to each part in the expression and an interpolating operation is performed according to the weight.

In these normal map synthesis and bump map synthesis, a shader of the GPU 10 is used to process pixel values of texture, such that wrinkle synthesis effect can be realistically performed. That is, the synthesis can be effectively obtained by using the shader.

If the maximum number of simultaneous textures of the GPU 10 is less than the number of expressions to be synthesized, the GPU 10 calculates the divided expression several times for corrections. In this case, the sum of the calculated normal map synthesis, which is calculated in the previous operation, and the weight is inputted into a current operation, and an additional expression is synthesized with the input for correction.

The rendering module 18 renders a wrinkled skin of a character through the weighted normal map and bump map through the above algorithm, and then displays character animation with the wrinkled skin in real time through a display 20.

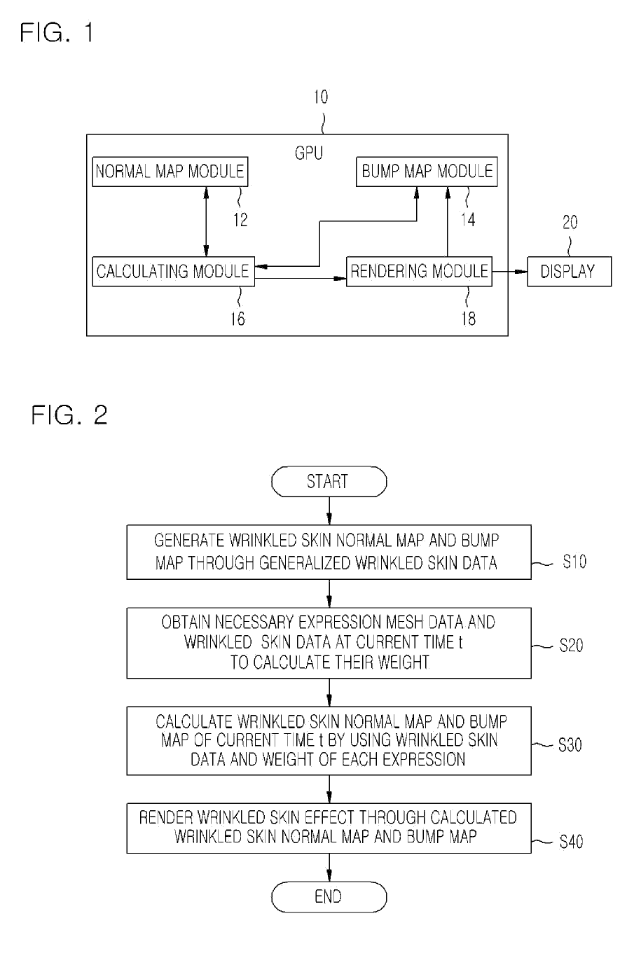

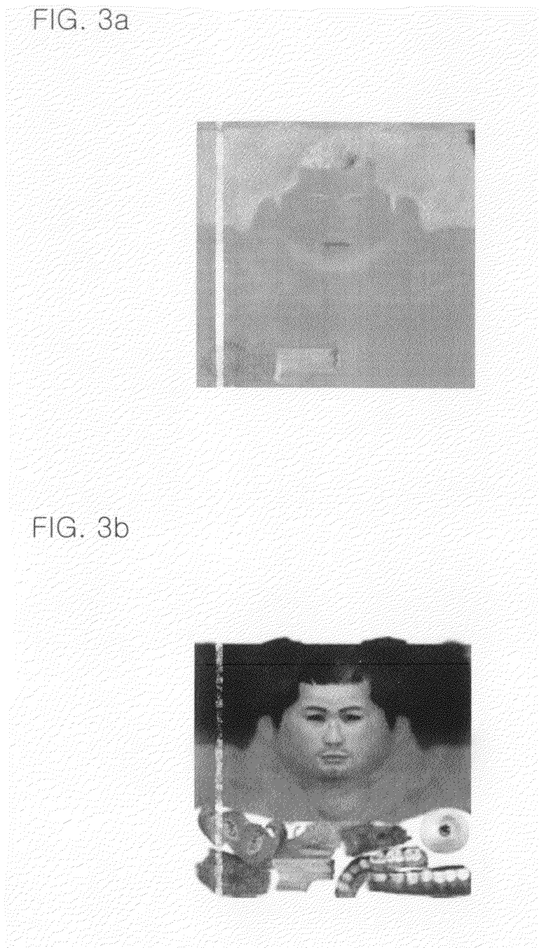

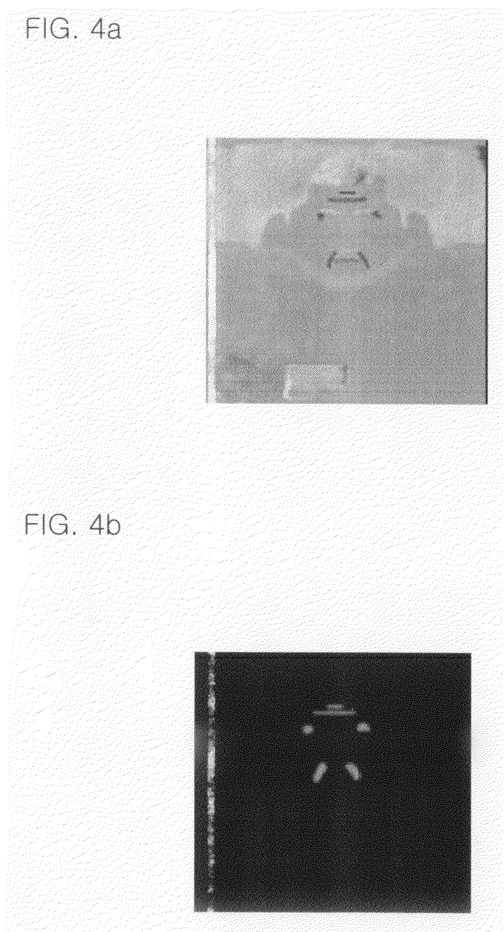

FIG. 2 illustrates a flowchart of a method for rendering a wrinkled skin in real-time during character animation according to one embodiment of the present invention. FIGS. 3A and 3B illustrate a bump map and a color map used in a character face according to one embodiment of the present invention. FIGS. 4A and 4B illustrate a bump map and a weight map expressing smile expression of a character according to one embodiment of the present invention.

Referring to FIGS. 2 through 4B, a method of rendering a character animation wrinkled skin for obtaining the above purpose includes extracting expressions of the character for synthesis at a current time t as illustrated in FIG. 2, and synthesizing the weighted weight map of FIG. 4B with the normal map or the bump map with a wrinkled skin of the character, that is, calculating and applying the weight to obtain a final normal map or a final bump map, and expressing the result by rendering the wrinkled skin through the final normal map or the final bump map. At this point, because FIG. 4B illustrates a weight map used for rendering a smile expression, a smiling face of the character can be rendered through the weight map of FIG. 4B.

First, the present invention will be described in an aspect of a face skin. However, the present invention is not limited to the face skin and can be applicable to all wrinkled surface of the character.

According to the present invention, since the normal map and the bump map are applied through the same method, the normal map is used for description. The normal map and bump map data necessary for the wrinkled skin synthesis make use of a case-based model, and the normal map module 12 generates a normal map by using the case-based model. Likewise, the bump map module 14 generates a bump map by using the case-based model in operation S10. That is, a method of generating the normal map and the bump map may model the cases of necessary expressions in advance then interpolate them.

The normal map and the bump map, which are respectively generated by the normal map module 12 and the bump map module 14, obtain wrinkle data of each expression case model by using 3D scanner equipment, a designer who directly designs through a 2D image, or various automated equipment. The wrinkle data of a case model at each expression calculates weighs at each part of the expression when interpolating the normal maps with the wrinkled skin at each expression in operation S20.

The weight ranges between 0 and 1. As weight approaches 0, its effect on a facial expression increases, and as weight approaches 1, affect on a facial expression decreases.

The weight data of a current expression uses the result of (neutral expression normal map—current expression normal map) as initial data. In a case of the bump map, the bump map of FIG. 3A is used as initial data. If it needs wrinkle data in a required place or a more detailed expression, it will be manually processed later.

The weight data may be an alpha portion of the normal map. Because the latest texture can express a floating point number, it will be more effective if used.

After generating normal and bump map case models with the wrinkled skin according to each expression, the weight is applied to the models for synthesis through interpolation in operation S30. FIG. 4B illustrates a weight map used for smile expression of a character. The synthesis of the wrinkled skin normal map is expressed in Equation 1 below.

Sum(Normal(expr, x, y)*Weight(expr, x, y))/Sum(Weight(expr, x, y)) Equation 1

wherein expr represents an index when expressions for synthesis are listed 1 . . . n (e.g., a plurality of models such as a smiling face, an angry face, a crying face, etc.), Normal(expr, x, y) represents a normal value at normal map (x, y) coordinates with respect to the wrinkled skin normal map of the final result, Normal(expr, x, y) represents a normal value at the normal map (x, y) coordinates, i.e., the wrinkled skin of the expression expr that will be currently synthesized, and Weight(expr, x, y) represents a weight at (x, y) coordinates of the expression that will be currently synthesized.

When being expressed like a face animation, the wrinkled skin normal map synthesis of the current face animation at time t is expressed in Equation 2 below.

Sum(Normal(expr, x, y)*Weight(expr, x, y)*TimedWeight(t, expr))/Sum(Weight(expr, x, y)*TimedWeight(t, expr)) Equation 2

wherein Normal(t, x, y) represents a normal value of (x, y) coordinates with respect to the wrinkled skin normal map of the final result at a current time t, and TimeWeight(t, expr) represents a synthesized weight of a corresponding wrinkle expression at a current time t.

This normal map synthesis may be more effective when using hardware (i.e., a shader) of the GPU 10.

The wrinkled skin normal map texture and weight at each expression are inputted into the shader, and the shader outputs the normal map to which synthesized weight at each pixel is applied through Equations 1 and 2.

If the maximum number of simultaneous textures of the GPU 10 is less than the number of expressions to be synthesized, the GPU 10 calculates the divided expression several times. As a result, the result can be fitted into an animation frame. In this case, the sum of the synthesis normal map and the weight, which are calculated in the previous operation, is inputted into a current operation, and this is synthesized with the additional expression. As s result, an image can be smoothly displayed in character animation.

Generalized expression normal map difference data and weight are required to generate expression with weighted wrinkle by applying one case expression normal map data to a normal map of another character. The generalized expression normal map difference data (general NormalMapDiff(expr, x, y) is calculated by using normal map data of a current case, and this is expressed in Equation 3.

general NormalMapDiff(expr, x, y)=Normal(expr, x, y)−Normal(neutralexpression, x, y) Equation 3

The normal map difference data and weight of each expression are calculated using Equation 3. The calculated normal map difference data may be applied to expressions of another character. In a case of applying the data to the expression of another character, this is expressed in Equation 4.

another character Normal(expr, x, y)=another character Normal(neutralexpression, x, y)+generalNormalMapDiff(expr, x, y) Equation 4

If another character has neutral expression, the normal maps of various expressions can be achieved by only using the normal map. FIG. 4A illustrates a bump map generating a smiling expression by applying the weight. At this point, a geometric structure of texture to which polygons refer is identical to those of FIGS. 3A through 4b. That is, an eye on the texture of a general case model needs to be coincided with that of another character. As illustrated in FIG. 3B, color is put on the face of a character with expressions to obtain the character with wrinkle.

As the description is made on the basis of the normal map, the same algorithm is applied to the bump map. The rendering module 18 renders data by using the normal map and bump map weighted through the algorithm in operation S40. The rendered data is displayed in the display 20.

By doing this, the wrinkled skin can be expressed in any face during animal character expression.

Other portion other then the face can be expressed by using the same method. The wrinkled skin can be expressed by generalizing the normal maps according to each movement and synthesizing them.

It will be apparent to those skilled in the art that various modifications and variations can be made in the present invention. Thus, it is intended that the present invention covers the modifications and variations of this invention provided they come within the scope of the appended claims and their equivalents.

1. A method of rendering a wrinkled skin in real time during character animation, the method comprising:
extracting expression of a character for a normal map synthesis at a current time and calculating weight of a wrinkled skin in a normal map expressed with the wrinkled skin of the expression;
adding the calculated weight to calculate a final normal map; and
rendering the wrinkled skin by using the calculated final normal map to express the wrinkled skin.

2. A method of rendering a wrinkled skin in real time during character animation, the method comprising:
extracting expression of a character for a bump map synthesis at a current time and calculating weight of a wrinkled skin in a bump map expressed with the wrinkled skin of the expression;
adding the calculated weight to calculate a final bump map; and
rendering the wrinkled skin by using the calculated final bump map to express the wrinkled skin.

3. The method of claim 2, wherein data of the bump map and the normal map are generated using a case-based model.

4. The method of claim 2, wherein a shader of a graphics processing unit (GPU) is used for the normal map synthesis and the bump map syntheses to process a pixel value of texture.

5. The method of claim 4, wherein when the maximum number of simultaneous textures of the GPU is less than the number of expressions to be synthesized, the expressions are divided several times, a sum of the calculated normal or bump map synthesis and the calculated weight are inputted into a current operation, and the inputted sum is synthesized with an additional expression for correction.

6. The method of claim 2, wherein the final normal map or the final bump map of another character is applied to the normal map or the bump map to obtain generalized expression normal map difference data, such that the normal map difference data and weight are calculated.

7. The method of claim 6, wherein polygon referring to a geometric structure of texture is applied in the same state to apply the final normal map or the final bump map of another character to the normal map or the bump map, respectively.

8. An apparatus for rendering a wrinkled skin in real time during character animation, the apparatus comprising:
a normal map module converting cases of necessary expressions into a normal map through an interpolation method after modeling the cases of necessary expressions;
a bump map module converting cases of necessary expressions into a bump map through an interpolation method after modeling the cases of necessary expressions;
a calculating module adding weight to the normal map or the bump map, the weight corresponding to expressions that will be synthesized with the weight, and synthesizing them, and then calculating the final normal map or the final bump map; and
a rendering module rendering a wrinkled skin of a character by using the weighted normal map or the bump map.

9. The method of claim 1, wherein data of the bump map and the normal map are generated using a case-based model.

10. The method of claim 1, wherein a shader of a graphics processing unit (GPU) is used for the normal map synthesis and the bump map syntheses to process a pixel value of texture.

11. The method of claim 10, wherein when the maximum number of simultaneous textures of the GPU is less than the number of expressions to be synthesized, the expressions are divided several times, a sum of the calculated normal or bump map synthesis and the calculated weight are inputted into a current operation, and the inputted sum is synthesized with an additional expression for correction.

12. The method of claim 1, wherein the final normal map or the final bump map of another character is applied to the normal map or the bump map to obtain generalized expression normal map difference data, such that the normal map difference data and weight are calculated.

13. The method of claim 12, wherein polygon referring to a geometric structure of texture is applied in the same state to apply the final normal map or the final bump map of another character to the normal map or the bump map, respectively.
